(19) United States
(12) Patent Application Publication
(10) Pub. No.: US 2010/0074580 A1
(43) Pub. Date: Mar. 25, 2010

(54) LIGHT SOURCE UNIT AND IMAGE DISPLAYING APPARATUS

(76) Inventors: Jyunichi AIZAWA, Tokyo (JP); Yoko INOUE, Tokyo (JP); Yukio SATO, Tokyo (JP); Mitoru YABE, Tokyo (JP); Hiroshi SASAKI, Tokyo (JP)

Correspondence Address: BIRCH STEWART KOLASCH & BIRCH, PO BOX 747, FALLS CHURCH, VA, 22040-0747, US

(21) Appl. No.: 12/548,092

(22) Filed: Aug. 26, 2009

(30) Foreign Application Priority Data
Sep. 22, 2008 (JP) 2008-242500
May 13, 2009 (JP) 2009-116557

(51) Int. Cl. G02B 6/32

(52) U.S. Cl. 385/33

(57) ABSTRACT

A light source unit includes a laser element that includes a plurality of light emitting points that are arranged along one direction on an end face thereof and irradiates laser beams having a spread in a spreading direction that is perpendicular to the one direction. A cylindrical lens held by a first body tube collimates the laser beams in block. Circular lenses held by a second body tube condense the collimated beams into an inlet of an optical fiber. The first body part and the second body part are positioned and directly coupled to each other so that an optical axis of the cylindrical lens accords with that of the circular lenses.

### BACKGROUND OF THE INVENTION

1. Field of the Invention

The present invention relates to a light source unit for use in a projector, a rear projection television, or a liquid crystal television as a back light.

2. Description of the Related Art

A conventional light source unit adjusts only a vertical-direction spread angle θv of a laser beam in which the vertical-direction spread angle θv is larger than a parallel-direction spread angle θp by using a first lens that is a cylindrical lens and adjusts both the spread angles θv and θp by using a second lens unit that includes a spherical lens and an aspherical lens, before condensing the laser beams into an optical fiber. Such a technology has been disclosed, for example, in Japanese Patent Application Laid-open No. 11-337866 (paragraphs 0012, 0025, and 0041, FIG. 1).

In another conventional technology, a light source unit collimates laser beams projected from a plurality of semiconductor laser devices by using collimator lenses corresponding to the semiconductor laser devices and then condenses the laser beams into a leading end of an optical fiber by using two cylindrical lenses. The collimator lenses and the cylindrical lenses are held in different packages. Such a technology has been disclosed, for example, in Japanese Patent Application Laid-open No. 2006-54366 (paragraphs 0035, 0039, and 0040, FIG. 2).

In still another conventional technology, a light source unit collimates laser beams projected from two semiconductor devices by using two collimator lenses and condenses the laser beams passing through the collimator lenses by using a condenser lens such as a spherical lens. An optical fiber is arranged at the focusing position. The two collimator lenses are arranged in a light source package while the condenser lens is arranged in an outer package that accommodates therein the light source package. Such a technology has been disclosed, for example, in Japanese Patent Application Laid-open No. 2006-66875 (paragraphs 0043, 0045, and 0046, FIG. 1).

Japanese Patent Application Laid-open No. 11-337866 discloses a technology to collimate laser beams having a vertical spread angle θv emitted from a semiconductor laser array of which a plurality of light emitting points are arranged at a predetermined pitch with a single cylindrical lens. However, Japanese Patent Application Laid-open No. 11-337866 does not disclose a specific method and configuration for holding the first lens (the cylindrical lens) and the second lens unit (the spherical lens and the aspherical lens) of the light source unit and positioning these lenses by matching the optical axes of the lenses with each other.

Moreover, Japanese Patent Application Laid-open No. 2006-54366 and Japanese Patent Application Laid-open No. 2006-66875 disclose technologies to collimate the laser beams emitted from the plurality of laser devices by the plurality of collimator lenses corresponding to the laser devices. However, because the number of lenses of the light source unit increases, the cost increases. In Japanese Patent Application Laid-open No. 2006-54366, the light source unit holds the collimator lens and the condenser lens (the cylindrical lens) in separate packages and couples the packages to each other. However, because the packages are not positioned, it is difficult to match a positional relationship between the collimator lens and the condenser lens. In Japanese Patent Application Laid-open No. 2006-66875, because the light source unit provides the light source package holding the collimator lens in the package holding the condenser lens, the packages are not positioned and the positioning between the packages is not easy.

### SUMMARY OF THE INVENTION

It is an object of the present invention to at least partially solve the problems in the conventional technology.

According to an aspect of the present invention, there is provided a light source unit including a laser element that includes a plurality of light emitting points that are arranged along one direction on an end face thereof and irradiates laser beams having a spread angle in a spreading direction that is perpendicular to the one direction; at least one cylindrical lens of which a direction of a generatrix is perpendicular to the spreading direction and that collimates the laser beams in block to obtain collimated laser beams; a first holder that houses therein and holds the cylindrical lens; at least one condenser lens that is arranged downstream of the cylindrical lens and condenses the collimated beams; and a second holder that houses therein and holds the condenser lens. The first holder and the second holder are positioned and directly coupled to each other so that an optical axis of the cylindrical lens accords with that of the condenser lens.

According to another aspect of the present invention, there is provided an image displaying apparatus including a light source unit; an image displaying device that forms an image on an illumination area to be illuminated; an illuminating optical system that illuminates the image displaying device by using the laser beams emitted from the light source unit; and a projection optical system that magnifies the image formed by the image displaying device and projects the magnified image on a screen. The light source unit including a laser element that includes a plurality of light emitting points that are arranged along one direction on an end face thereof and irradiates laser beams having a spread angle in a spreading direction that is perpendicular to the one direction; at least one cylindrical lens of which a direction of a generatrix is perpendicular to the spreading direction and that collimates the laser beams in block to obtain collimated laser beams; a first holder that houses therein and holds the cylindrical lens; at least one condenser lens that is arranged downstream of the cylindrical lens and condenses the collimated beams; and a second holder that houses therein and holds the condenser lens. The first holder and the second holder are positioned and directly coupled to each other so that an optical axis of the cylindrical lens accords with that of the condenser lens.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective diagram of a light source unit according to a first embodiment of the present invention;

FIG. 2 is a horizontal cross-sectional view, seen from its bottom, of the light source unit shown in FIG. 1;

FIG. 3 is a vertical cross-sectional view, seen from its right, of the light source unit shown in FIG. 1;

FIG. 4 is a partially cross-sectional and perspective diagram of a lens unit shown in FIG. 1 that holds a cylindrical lens of the light source unit;

FIG. 5 is a partially cross-sectional and perspective diagram of a lens unit shown in FIG. 1 that holds a circular lens (a condenser lens) of the light source unit;

FIG. 6 is a vertical cross-sectional view of the lens unit shown in FIG. 5;

FIG. 7 is an exploded perspective diagram explaining an adjusting method of an optical fiber holder of the light source unit shown in FIG. 1;

FIG. 8 is a cross-sectional view explaining a configuration of an optical sensor unit of the light source unit shown in FIG. 1; and

FIG. 9 is a schematic diagram of a projection-type display apparatus according to a second embodiment of the present invention using the light source unit according to the first embodiment of the present invention.

### DETAILED DESCRIPTION OF THE PREFERRED EMBODIMENTS

Exemplary embodiments of the present invention will be explained in detail below with reference to the accompanying drawings. However, the present invention is not limited to these embodiments.

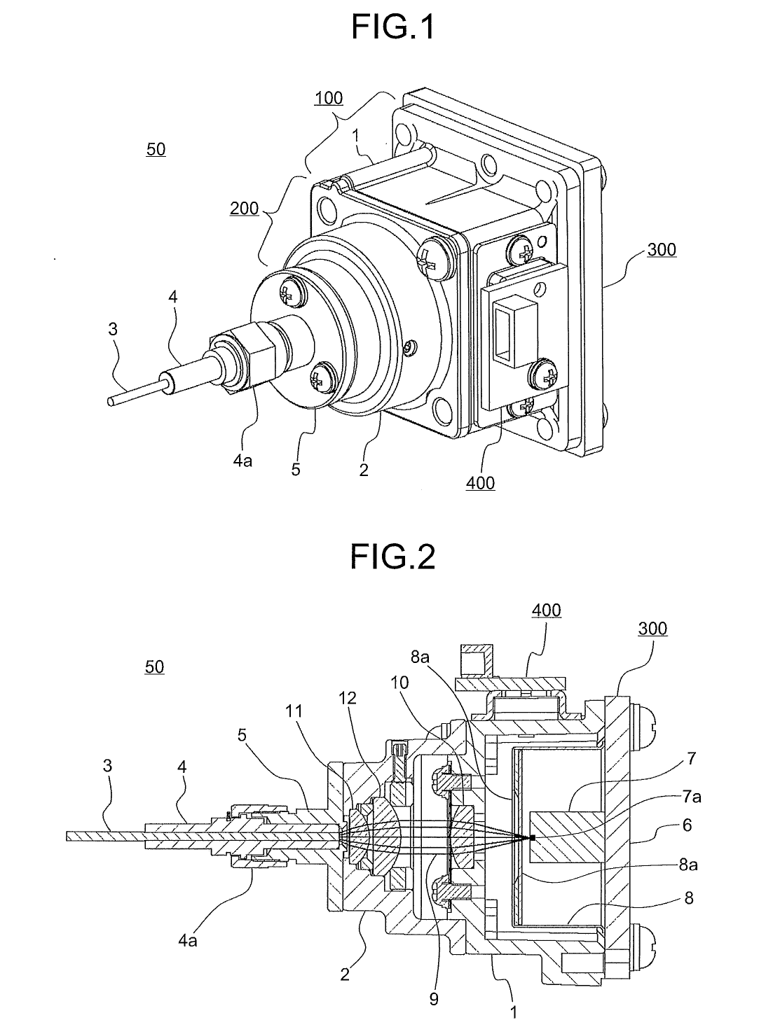

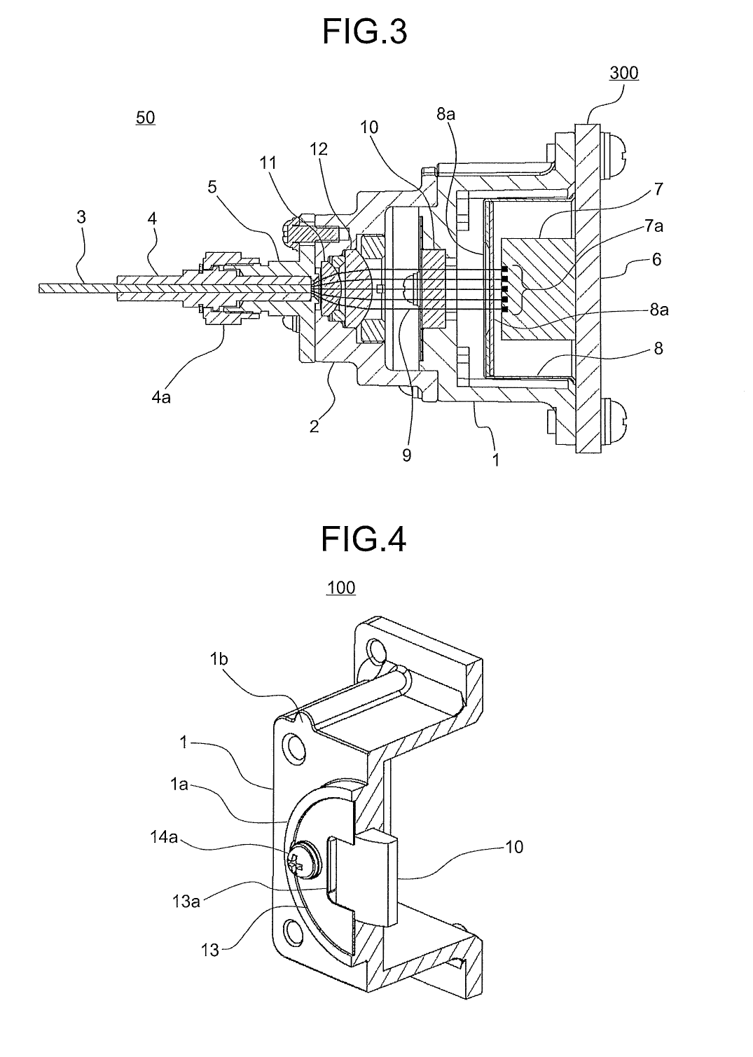

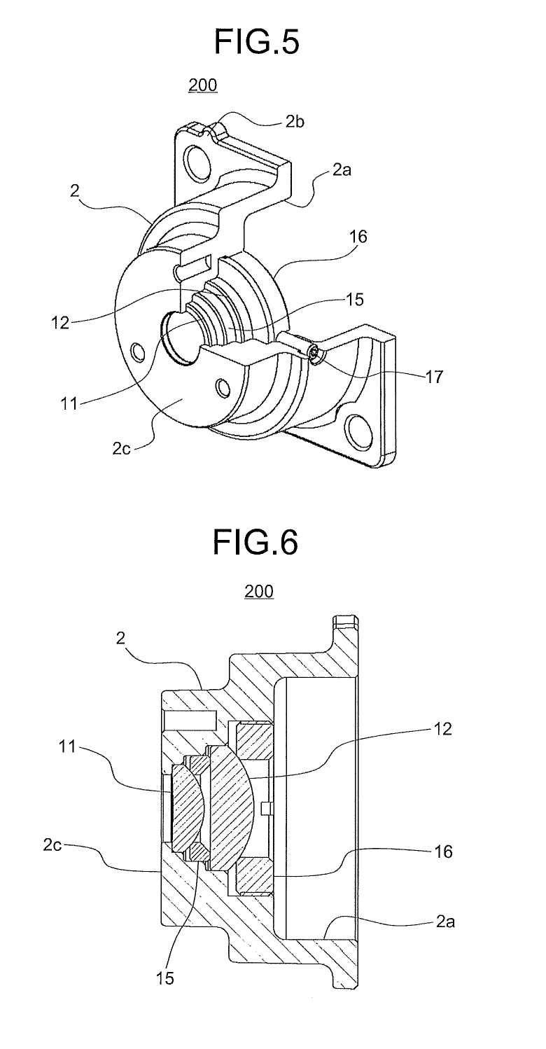

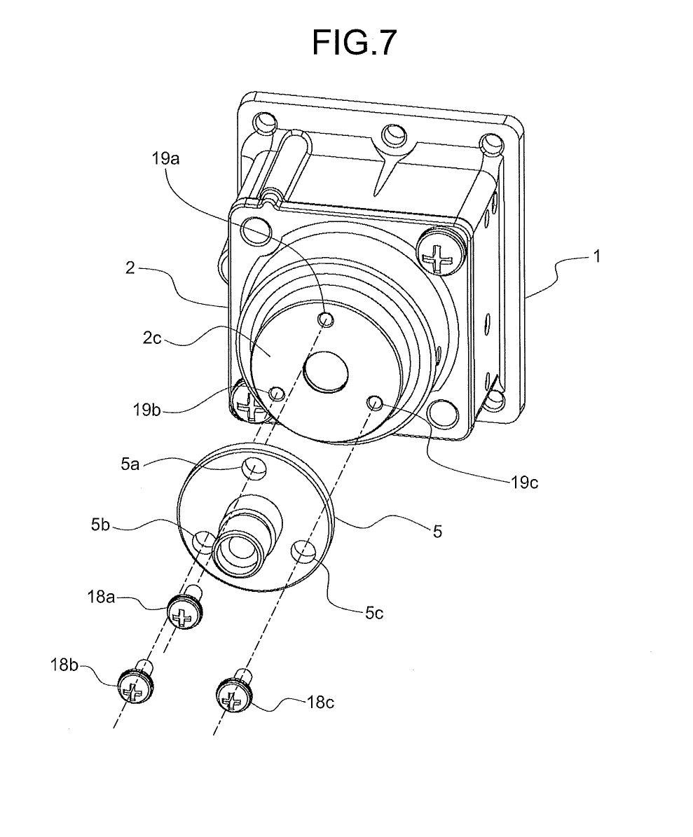

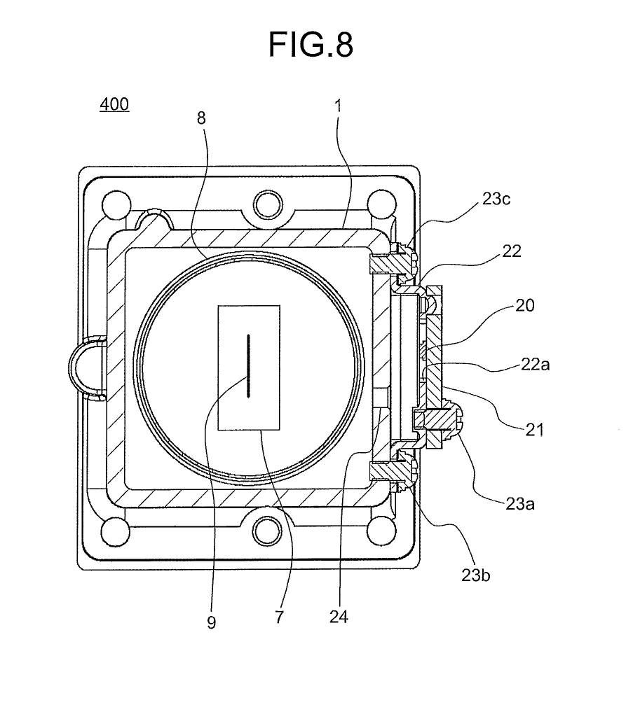

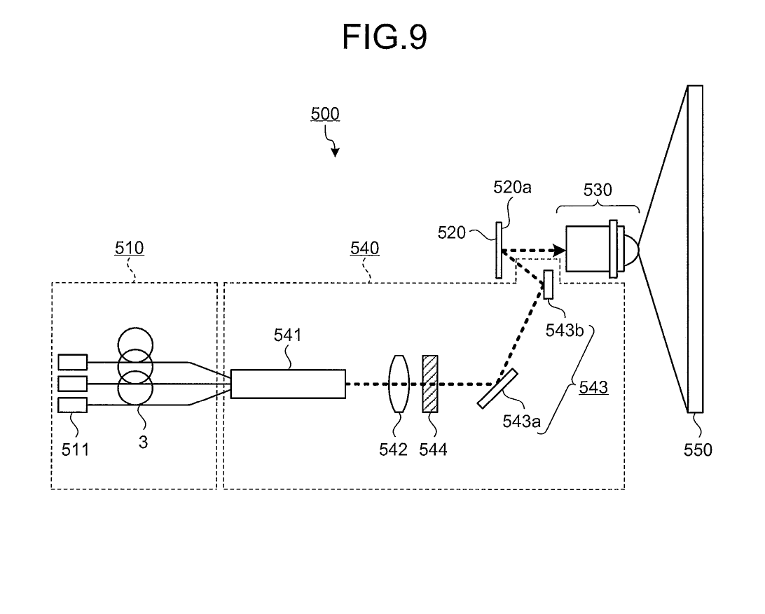

Hereinafter, a light source unit 50 according to a first embodiment of the present invention will be explained with reference to the drawings. FIG. 1 is a perspective diagram of the light source unit 50. FIG. 2 is a horizontal cross-sectional view, seen from its bottom, of the light source unit 50. FIG. 3 is a vertical cross-sectional view, seen from its right, of the light source unit 50. FIG. 4 is a partially cross-sectional and perspective diagram of a lens unit 100 that holds a cylindrical lens. In FIG. 4, components other than the cylindrical lens are illustrated as a vertical cross-sectional view. FIG. 5 is a partially cross-sectional and perspective diagram of a lens unit 200 that holds a circular lens that is a condenser lens. In FIG. 5, only a body part is illustrated as a partially cross-sectional view. FIG. 6 is a vertical cross-sectional view of the lens unit 200. FIG. 7 is an exploded perspective diagram explaining an adjusting method of an optical fiber holder 5. FIG. 8 is a cross-sectional view of an optical sensor unit 400 when the lens unit 100 is sectioned in a direction vertical to an optical axis at a position of the optical sensor unit 400. FIG. 9 is a schematic diagram of a projection-type display apparatus according to a second embodiment of the present invention using the light source unit according to the first embodiment of the present invention.

As illustrated in FIG. 1, the light source unit 50 includes a first body part 1, a second body part 2, the optical fiber holder 5, a laser module 300, and the optical sensor unit 400. The first body part 1 holds a cylindrical lens. The second body part 2 holds a circular lens. The optical fiber holder 5 is fixed with a cap nut 4a and a connector 4 holds an optical fiber 3. The laser module 300 is coupled to the rear end of the first body part 1 and irradiates laser beams. The optical sensor unit 400 is coupled to a lateral side of the first body part 1 and detects light.

As illustrated in FIGS. 2 and 3, the laser module 300 includes a base plate 6, a laser element 7 that is mounted on the base plate 6, and a cap 8 that is coupled to the base plate 6 and encloses the laser element 7. Moreover, the laser module 300 is positioned at the rear end of the first body part 1 and is coupled to the first body part 1. An end face of the laser element 7 has five light emitting points 7a arranged along a straight line. Each light emitting point 7a irradiates a laser beam 9 that spreads in a direction perpendicular to the line along which they are arranged. In the horizontal cross-sectional view illustrated in FIG. 2, the five light emitting points 7a are seen as one point because they are arranged on a line that is perpendicular to the plane of the paper and irradiate the laser beams 9 having the same spread angle in a transverse direction. On the other hand, in the vertical cross-sectional view illustrated in FIG. 3, all the five light emitting points 7a are seen because they are arranged on a line that is in the plane of the paper and the laser beams 9 irradiated from the light emitting points 7a go straight ahead without spreading in a longitudinal direction. The number of the light emitting points is not limited to five. The number of the light emitting points can be changed depending on the requirement. Moreover, all of the light emitting points need not be arranged along a single line, i.e., they can be arranged along two lines if they are in a large number.

The first body part 1 holds a cylindrical lens 10. The cylindrical lens 10 is arranged so that a direction of a generatrix thereof is perpendicular to the spreading direction of the laser beam 9. The second body part 2 holds two circular lenses 11 and 12. The second body part 2 is positioned against the first body part 1 and is coupled to the first body part 1 in such a manner that the optical axis of the circular lenses 11 and 12 accords with the optical axis of the cylindrical lens 10. The number of the cylindrical lenses is not limited to one and the number of the circular lenses is not limited to two. The number of these lenses can be changed depending on a constrained condition such as a required performance, a cost, or a size.

The optical fiber 3 is inserted into the connector 4 and then the leading end of the optical fiber 3 is fixed to the leading end of the connector 4 with adhesive to accord with each other. Moreover, the optical fiber holder 5 is coupled to the outlet-side leading end of the second body part 2. The leading end of the assembly of the optical fiber 3 and the connector 4 is inserted into the outlet-side leading end of the second body part 2 and the assembly is fixed to the second body part 2 with the cap nut 4a. At this time, because the leading end of the assembly hits against and is stopped at the bottom of the hole of the optical fiber holder 5, the leading end of the optical fiber 3 is positioned in a depth direction. For purposes of illustration, the optical fiber 3 illustrated in FIGS. 1 to 3 indicates the state wherein the optical fiber is halfway cut; however, in practice the optical fiber is long. Moreover, the optical fiber is shown naked; however, in practice it is coated.

Next, the action of the light source unit will be explained. The laser beams 9 irradiated from the light emitting points 7a pass through a glass window 8a provided in the cap 8 and is incident on the cylindrical lens 10. As illustrated in FIG. 2, when the laser beams 9 pass through the cylindrical lens 10 the spread of the beams is corrected in a transverse direction so that the beams become parallel beams. On the other hand, as illustrated in FIG. 3, the laser beams 9 do not have a spread in a longitudinal direction, i.e., they are parallel beams parallel to the optical axis, so that they pass through the cylindrical lens 10 without being refracted. Therefore, when the laser beams 9 exit from the outlet of the cylindrical lens 10 they are parallel beams in both vertical and horizontal directions.

Next, the laser beams 9, which are incident on the circular lens 12, are refracted by the circular lens 12 and the circular lens 11 in both vertical and horizontal directions and are condensed into the inlet of the optical fiber 3. The laser beams 9, which are incident on the optical fiber 3, are propagated through the optical fiber 3 and are transmitted to a destination through the optical fiber 3.

As described above, the laser beams 9, which are irradiated from the light emitting points 7a and have the spread angle in a direction perpendicular to the array direction, are collimated by the cylindrical lens 10 in vertical and horizontal directions. Therefore, the laser beams can be then condensed by the circular lenses 11 and 12 at the leading end of the optical fiber 3 with high precision.

Because the laser beams 9 irradiated from the plurality of light emitting points 7a can be collimated by the single cylindrical lens 10, it is not necessary to provide one collimator lens for each light emitting point 7a. Moreover, a shorter assembling time is required for positioning the single collimator lens 10 with respect to the plurality of light emitting points 7a as compared to a case of positioning one collimator lens for each light emitting point. In addition, the number of parts can be reduced and the total cost including the assembly cost can be reduced.

Next, the detailed configuration of the lens unit 100 will be explained with reference to FIG. 4. In the lens unit 100, the cylindrical lens 10 is held at the outlet side of the first body part 1 from which the laser beams 9 exit. Moreover, the cylindrical lens 10 is pushed toward the first body part 1 by a plate spring 13 and is held without backlash. The plate spring 13 is firmly attached to the first body part 1 with screws 14a (only one screw 14a can be seen in FIG. 4). Moreover, the plate spring 13 has a window 13a through which the laser beams 9 pass.

Next, how the lens unit 200 is assembled will be explained with reference to FIGS. 5 and 6. First, the circular lens 11 is inserted into the second body part 2 and then a doughnut-shaped spacer 15 is inserted into the second body part 2. Next, the circular lens 12 is inserted into the second body part 2 and is fixed by a screw ring 16. The outer circumference of the screw ring 16 is provided with screw threads. The assembling can be made easily if the second body part 2 is held in such a manner that its outlet side points downward and components are dropped and piled up. Finally, the second body part 2 is firmly attached by a set screw 17 from the lateral side of the second body part 2 to prevent the screw ring 16 from being loosened due to a vibration or the like.

Subsequently, the assembly of the lens unit 100 and the lens unit 200 are performed so that the optical axis of the cylindrical lens 10 accords with the optical axis of the circular lenses 11 and 12. This is done by fitting a cylindrical fitting surface 2a, which is provided in the inner surface of the second body part 2 and has the same axis as the optical axis of the circular lenses 11 and 12, in a cylindrical protrusion 1a that is provided at the outlet side of the first body part 1 and has the same axis as the optical axis of the cylindrical lens 10. In addition, the positioning of a rotation direction is performed by matching a protrusion 1b provided in the first body part 1 with a protrusion 2b provided in the second body part 2 at the time of assembly.

As described above, the first body part 1 and the second body part 2 are positioned and are directly coupled to each other and thus the optical axis of the cylindrical lens 10 held in the first body part 1 can be accurately matched with the optical axis of the circular lenses 11 and 12 held in the second body part 2. Therefore, the decrease of performance does not occur due to the deviation of optical axis. Moreover, because the cylindrical lens and the circular lens are held in separate body parts, the shape of body part can have a shape suitable for each lens of the cylindrical lens and the circular lens. In other words, the body part holding the circular lens can use a body part of which a cross section is circular and thus can be machined as a cylinder by using a lathe when additionally machining an inner surface or the like. Therefore, a machining accuracy is high, a machining time is short, and the total cost can be reduced. Moreover, the optical axis of a lens is easily secured and the components can be assembled by dropping them in the case of assembly when the body part is circular. Therefore, the assembling becomes simple, assembling time can be shortened, and thus total cost including the assembly cost can be reduced.

Because the body part holding the cylindrical lens can have a square cross section and have a shape suited for the outer shape of the cylindrical lens, its thickness can be equalized and thus materials can be efficiently used. When the cylindrical lens and the circular lens exist together, the body part has a complicated form and thus it is hard to shape the body part and to additionally machine the body part. Therefore, it is hard to secure accuracy and it is difficult to suppress the cost.

Next, a mounting arrangement of the optical fiber holder 5 and a positioning method of the optical fiber 3 will be explained with reference to FIG. 7. The optical fiber holder 5 is screwed to an outlet surface 2c of the second body part 2 with three screws 18a to 18c. The outlet surface 2c of the second body part 2 is flat. Three female screws 19a to 19c are formed in the outlet surface 2c at an interval of 120 degrees. The optical fiber holder 5 is mounted on the outlet surface 2c and then the optical fiber holder 5 and the second body part 2 are lightly fastened by the screws 18a to 18c for the time being. Next, the assembly of the optical fiber 3 and the connector 4 is inserted into the optical fiber holder 5 and they are fixed to each other. In addition, the positioning of the optical fiber 3 is performed in a state where the laser module 300 illustrated in FIGS. 1 to 3 is coupled to the body part and the laser beams 9 are irradiated.

When performing positioning, the screws 18a to 18c, which have been temporarily fastened, are first loosened. When the screws 18a to 18c are loosened, the optical fiber holder 5 can be slid over the outlet surface 2c to perform positioning. The optical fiber holder 5 can be moved by the backlash of holes 5a to 5c punctured therein and the screws 18a to 18c. As illustrated in FIGS. 2 and 3, because the laser beams 9 are condensed at the point at which the optical fiber 3 should be located originally, the inlet end face of the optical fiber 3 can be matched with a condensing point by moving the optical fiber holder 5 in the plane of the outlet surface 2c. The judgment about whether the leading end of the optical fiber 3 accords with the condensing point is performed by measuring the intensity of the laser beams 9 that are output from the outlet of the optical fiber 3. The optical fiber holder 5 is fixed by strongly tightening the screws 18a to 18c at the position at which the intensity becomes the maximum.

Because the optical fiber holder 5 is held to be movable in the plane of the outlet surface 2c of the second body part 2, a complicated adjustment mechanism is unnecessary. Therefore, a mechanism for positioning the optical fiber 3 that has lesser parts, lower manufacturing cost, and higher reliability can be obtained. Moreover, because the positioning of the optical fiber 3 can be performed without deviating the inlet end face of the optical fiber 3 in an optical axis direction, a high-accuracy positioning can be performed.

The configuration of the optical sensor unit 400 is explained with reference to FIG. 8. In the optical sensor unit 400, an optical sensor 20 is mounted on a board 21 and the board 21 is fixed to a board holder 22 by a screw 23a. A window 22a into which the optical sensor 20 enters is provided in the board holder 22. The board 21 is fixed to the lateral side of the first body part 1 by using two screws 23b and 23c. In this case, the bottom side of the board 21 corresponds to a mounting surface of the optical sensor 20. Moreover, the board holder 22 has a bathtub-type structure so that the optical sensor 20 is not attached firmly to the lateral side of the first body part 1 and is held to provide a space between the first body part 1 and the optical sensor 20. Moreover, a photodetection hole 24 is provided in the lateral side of the first body part 1. The laser beams 9 are entered into the board holder 22 from the hole.

The laser beams 9 are blocked by the cap 8 so that they do not directly enter into the hole 24. The laser beams 9 are slightly reflected on the incident plane of the cylindrical lens 10 illustrated in FIG. 2 and further are irregularly reflected within the first body part 1. The hole 24 is provided at the position at which the scattered light reflected irregularly is acquired. Furthermore, because the size of hole is set to an appropriate size and the optical sensor 20 is arranged at the position deviated from the axis line of the hole 24 so that the optical sensor 20 is not located on the axis line of the hole 24, the laser beams 9 are reflected and attenuated in the board holder 22. To further attenuate the laser beams 9, the inner surface of the board holder 22 can be made irregular or painted black.

Because the position of the hole 24 that is provided in the first body part 1 and acquires the laser beams, the positional relationship between the optical sensor 20 and the hole 24, and the shape or color of the board holder 22 that holds the board 21 for mounting thereon the optical sensor 20 are determined as described above, the laser beams 9 can be detected stably even if the beams have high intensity. Moreover, because the optical sensor 20 detects the intensity of the laser beams 9 and monitors the change of intensity of the laser beams, it is possible to judge a sudden malfunction and lifetime of the laser element 7. In addition, because the intensity of the laser beams 9 is compared with the output of the outlet side of the optical fiber 3, it is possible to detect the breaking of wire or the degradation of transmission factor of the optical fiber 3.

FIG. 9 is a configuration diagram of a projection-type display apparatus 500 as an image displaying apparatus that incorporates the light source unit according to the first embodiment of the present invention. The projection-type display apparatus 500 is a rear projection television that projects an image on a screen by using a light valve.

As illustrated in FIG. 9, the projection-type display apparatus 500 includes a condensing optical system 510, an illuminating optical system 540, and a reflecting optical modulator (a reflecting light valve) 520 acting as an image displaying device, and a projection optical system 530 that magnifies an image of an illuminated surface (an image forming area) 520a of the reflecting optical modulator 520, which is illuminated by the illuminating optical system 540 and projects the magnified image on a transmission screen 550.

The condensing optical system 510 includes light source units 511 corresponding to a plurality of colors (three colors in the example shown in FIG. 9) and the plurality of optical fibers 3 (three in the example shown in FIG. 9) that guides light beams emitted from the light source units 511 to the illuminating optical system 540. Among the plurality of light source units 511, at least one has a configuration identical to the light source unit 50 according to the first embodiment.

In the condensing optical system 510, the laser beams emitted from the light source units 511 are guided to the illuminating optical system 540 via the optical fibers 3 corresponding to the respective light source units 511.

The illuminating optical system 540 includes a light intensity uniformizing device 541 that uniformizes the intensity distribution of the laser beams emitted from the condensing optical system 510 (the optical fibers 3), a relay lens group 542, a diffusion device 544, and a mirror group 543 having a first mirror 543a and a second mirror 543b. The illuminating optical system 540 guides light beams emitted from the light intensity uniformizing device 541 to the reflecting optical modulator 520 by using the relay lens group 542 and the mirror group 543.

The light intensity uniformizing device 541 has a function (for example, a function for reducing the unevenness of illuminance) for uniformizing the light intensity of the laser beams emitted from the condensing optical system 510. The light intensity uniformizing device 541 is arranged inside the illuminating optical system 540 so that an incoming surface (an inlet end face) of the light intensity uniformizing device 541 that is an inlet of light is directed to the optical fiber 3 and an outgoing surface (an outlet end face) that is an outlet of light is directed to the relay lens group 542. The light intensity uniformizing device 541 is formed of transparent materials such as glass or resin. The light intensity uniformizing device 541 includes a polygonal pillar-shaped rod (referred to as a polygonal pillar-shaped holder from a cross sectional shape thereof) of which the inside of the side wall forms a total reflecting surface, a tubular pipe (a tube-shaped holder) of which the cross sectional shape is a polygon and the light reflection surface is present inside the pipe, and so on.

When the light intensity uniformizing device 541 is a multiangular pillar-shaped rod, the light intensity uniformizing device 541 reflects light multiple times and then emits the light from an outgoing end (an outlet) thereof by using a total-reflection action between transparent material and air interface. When the light intensity uniformizing device 541 is a polygonal pipe, the light intensity uniformizing device 541 reflects light multiple times and then emits the light from the outlet by using a reflex action of a surface-coated mirror that is directed inside.

If the light intensity uniformizing device 541 has a suitable length in a traveling direction of light beam, the light reflected inside multiple times is irradiated with an overlap in the vicinity of the outgoing surface of the light intensity uniformizing device 541. Therefore, substantially uniform intensity distribution is obtained in the neighborhood of the outgoing surface of the light intensity uniformizing device 541. The outgoing beams having the substantially uniform intensity distribution, which are output from the outgoing surface, are guided to the reflecting optical modulator 520 via the relay lens group 542 and the mirror group 543 and then illuminate the illuminated surface 520a of the reflecting optical modulator 520.

Moreover, the illuminating optical system 540 includes the diffusion device (a diffusion unit) 544 behind the relay lens group 542. The diffusion device 544 is a device that diffuses the light propagated through the relay lens group 542 and sends the diffused light to the mirror group 543 to reduce a speckle. For example, the diffusion device 544 is a holographic diffusion device that can set the diffusion angle of light in accordance with a hologram pattern performed on a substrate thereof and that mitigates the coherency of the light source units 511. Moreover, the coherency of the light source units 511 can be effectively mitigated by rotating or vibrating the diffusion device 544.

The reflecting optical modulator 520 is a reflecting optical modulator such as DMD (Digital Micro-mirror Device). The reflecting optical modulator 520 is obtained by arraying mobile micro-mirrors (for example, hundreds of thousands of pieces) corresponding to pixels in a planar manner and is constituted to change the tilt of each micro-mirror in accordance with pixel information.

The projection optical system 530 magnifies an image of the illuminated surface (image forming area) 520a of the reflecting optical modulator 520 and projects the magnified image on the transmission screen 550. In this way, the image is displayed on the transmission screen 550.

The number of lenses in the relay lens group 542 is not limited to one. That is, the relay lens group 542 can contain two or more lenses. The number of lenses may be plural pieces. Similarly, the number of lenses in the mirror group 543 is not limited to two. That is, the mirror group 543 can contain one lens or three or more lenses.

In FIG. 9, the laser beams emitted from the light source units 511 corresponding to the plural colors are guided to the illuminating optical system 540 via the optical fibers 3 corresponding to the respective light source units 511. However, the laser beams emitted from the light source units 511 may be combined by a dichroic mirror or the like and then be incident on the illuminating optical system 540.

As described above, according to an aspect of the present invention, the light having the spread angle irradiated from the laser element can be condensed with high precision.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light source unit comprising:
a laser element that includes a plurality of light emitting points that are arranged along one direction on an end face thereof and irradiates laser beams having a spread angle in a spreading direction that is perpendicular to the one direction;
at least one cylindrical lens of which a direction of a generatrix is perpendicular to the spreading direction and that collimates the laser beams in block to obtain collimated laser beams;
a first holder that houses therein and holds the cylindrical lens;
at least one condenser lens that is arranged downstream of the cylindrical lens and condenses the collimated beams; and
a second holder that houses therein and holds the condenser lens, wherein
the first holder and the second holder are positioned and directly coupled to each other so that an optical axis of the cylindrical lens accords with that of the condenser lens.

2. The light source unit according to claim 1, wherein the condenser lens condenses the collimated beams into an inlet of an optical fiber arranged downstream of the condenser lens.

3. The light source unit according to claim 1, wherein the condenser lens condenses the collimated beams into an inlet of a light intensity uniformizing device arranged downstream of the condenser lens.

4. The light source unit according to claim 1, wherein at least one of the condenser lenses is a circular lens having a circular outer shape.

5. The light source unit according to claim 1, further comprising:
a cylindrical protrusion of which a central axis is the same as the optical axis of the cylindrical lens and that is provided in an outlet-side surface of the first holder; and
a cylindrical fitting surface of which a central axis is the same as the optical axis of the condenser lens and is provided in an inlet-side inner surface of the second holder, wherein
the cylindrical protrusion is fitted into the cylindrical fitting surface to accord the optical axis of the cylindrical lens with the optical axis of the condenser lens.

6. The light source unit according to claim 1, further comprising an optical fiber holder that is held in an outlet surface of the second holder in a movable manner in a plane perpendicular to an optical axis of the light source unit.

7. The light source unit according to claim 1, further comprising:
a photodetection hole that is provided at a position at which the laser beams of the first holder do not strike directly;
an optical sensor configured to detect the laser beams;
a board configured to mount thereon the optical sensor; and
a board holder that holds the board so that the optical sensor is located at a location deviated from an axis line of the hole.

8. An image displaying apparatus comprising:
a light source unit;
an image displaying device that forms an image on an illumination area to be illuminated;
an illuminating optical system that illuminates the image displaying device by using the laser beams emitted from the light source unit; and
a projection optical system that magnifies the image formed by the image displaying device and projects the magnified image on a screen,
the light source unit including:
a laser element that includes a plurality of light emitting points that are arranged along one direction on an end face thereof and irradiates laser beams having a spread angle in a spreading direction that is perpendicular to the one direction;
at least one cylindrical lens of which a direction of a generatrix is perpendicular to the spreading direction and that collimates the laser beams in block to obtain collimated laser beams;
a first holder that houses therein and holds the cylindrical lens;
at least one condenser lens that is arranged downstream of the cylindrical lens and condenses the collimated beams; and
a second holder that houses therein and holds the condenser lens, wherein
the first holder and the second holder are positioned and directly coupled to each other so that an optical axis of the cylindrical lens accords with that of the condenser lens.
